(19) United States
(12) Patent Application Publication
(10) Pub. No.: US 2024/0167420 A1
(43) Pub. Date: May 23, 2024

(54) AIRCRAFT COMPRISING AT LEAST ONE AIR INTAKE DEVICE CONFIGURED TO LIMIT THE ONSET OF AERODYNAMIC NOISE

(71) Applicant: Airbus Operations SAS, TOULOUSE (FR)

(72) Inventors: Thierry FARGIER, TOULOUSE (FR); Maria Del Sagrario JUANAS FERNANDEZ, TOULOUSE (FR); Thomas NODE LANGLOIS, TOULOUSE (FR); Stéphane GALDEANO, TOULOUSE (FR); Jean-Paul ROMEO, TOULOUSE (FR)

(21) Appl. No.: 18/512,732

(22) Filed: Nov. 17, 2023

(30) Foreign Application Priority Data
Nov. 22, 2022 (FR) 2212127

(51) Int. Cl. F02C 7/045; B64D 33/02

(52) U.S. Cl. CPC F02C 7/045; B64D 33/02; B64D 2033/0206; F05D 2260/96

(57) ABSTRACT

An aircraft including at least one air intake device including an air inlet opening onto an aerodynamic wall, and having a first end positioned on a reference surface of the aerodynamic wall that is substantially parallel to an airflow flowing along the aerodynamic wall in operation. The air intake device includes at least one protrusion projecting from the reference surface and positioned upstream of the air inlet in the direction of flow of the airflow, in the vicinity of or at the first end of the air inlet. This protrusion makes it possible to limit the onset of aerodynamic noise.

### CROSS-REFERENCES TO RELATED APPLICATIONS

This application claims the benefit of the French patent application No. 2212127 filed on Nov. 22, 2022, the entire disclosures of which are incorporated herein by way of reference.

### FIELD OF THE INVENTION

The present application relates to an aircraft comprising at least one air intake device configured to limit the onset of aerodynamic noise.

### BACKGROUND OF THE INVENTION

As shown in FIG. 1, according to one embodiment, an aircraft 10 comprises a fuselage 12, wings 14 arranged on either side of the fuselage 12, and propulsion units 16 connected to the wings by pylons 18. The aircraft 10 also comprises at least one air-conditioning equipment and at least one air intake device 20, visible in FIG. 2, configured to convey the air towards the air-conditioning equipment. This air intake device opens onto an aerodynamic wall 22 in contact with an airflow 24 when the aircraft 10 is in flight, this aerodynamic wall being provided on the fuselage 12, on a wing 14, on a propulsion unit 16 or on a pylon 18.

According to one configuration, the air intake device 20 comprises an air inlet 26 secured to the aerodynamic wall 22, an intake duct 28 secured to an engine of a propulsion unit 16, and a ring joint 30 connecting the air inlet 26 and the intake duct 28.

The air inlet 26 comprises a flared upstream portion 32 which has an emergent end 32.1 connected to the aerodynamic wall 22, a substantially tubular downstream portion 34 having an end 34.1 oriented towards the intake duct 28, and a junction zone 36 where the flared downstream and upstream portions 32, 34 meet as well as a first flange 38 provided on the outside of the downstream portion 34 and positioned approximately at the junction zone 36.

According to one embodiment, the air inlet 26 is of the flush type. Thus, the emergent end 32.1 of the flared upstream portion 32 is positioned in a reference surface Sr substantially parallel to the airflow 24.

The intake duct 28 comprises a valve 40 configured to occupy an open state in which it leaves the intake duct 28 uncovered and a closed state in which it occludes the intake duct 28. The latter comprises an end 28.1 oriented towards the air inlet 26 and a second flange 42 at the end 28.1.

The downstream portion 34 of the air inlet 26 and the intake duct 28 are substantially aligned and have the same axis A and the same inside diameter.

According to one configuration, the axis A of the downstream portion 34 of the air inlet 26 and of the intake duct 28 is not perpendicular to the reference surface Sr. This axis A is inclined in the direction of flow of the airflow 24 and makes an angle of approximately 60° with the reference surface Sr.

The first and second flanges 38, 42 are separated from one another. They are substantially mutually parallel.

The ring joint 30 has a C-shaped cross section, a first branch 30.1 of the C-shape being connected to the first flange 38, a second branch 30.2 of the C-shape being connected to the second flange 42.

The air intake device 20 is optimized for reducing the drag of the aircraft when the valve 40 is in the open state.

When the valve 40 is in the closed state, the air inlet 26 and that part of the intake duct 28 that is situated upstream of the valve 40 form a closed cavity 44 depicted schematically in FIG. 3. The airflow 24 that flows over the closed cavity 44 generates aerodynamic noise, notably a whistling noise, because of the coupling between a return airflow 24.1 formed in the closed cavity 44 and a disturbed flow 24.2 that appears after the upstream edge 44.1 of the closed cavity 44.

The present invention aims to overcome all or some of the drawbacks of the prior art.

### SUMMARY OF THE INVENTION

To this end, the invention relates to an aircraft comprising at least one aerodynamic wall along which an airflow flows in a direction of flow during operation, as well as at least one air intake device comprising an air inlet opening onto the aerodynamic wall, an intake duct separated from the air inlet and a ring joint connecting the air inlet and the intake duct while surrounding these, the air inlet extending between a first end positioned on a reference surface substantially parallel to the airflow and a second end oriented towards the intake duct, the latter having a first end oriented towards the air inlet and spaced away from the second end of the air inlet.

According to the invention, the air intake device comprises at least one protrusion projecting from the reference surface and positioned upstream of the air inlet in the direction of flow of the airflow, in the vicinity of or at the first end of the air inlet.

The protrusion 70 makes it possible to reduce aerodynamic noise.

According to another feature, the protrusion and the air inlet exhibit a continuous profile with no points of inflection.

According to another feature, the air inlet is substantially symmetrical with respect to a longitudinal midplane, the protrusion being positioned symmetrically about the longitudinal midplane.

According to another feature, the protrusion has a summit and a height at the summit that is greater than or equal to 10 mm.

According to another feature, the protrusion is linear and extends along a path that is symmetrical with respect to the longitudinal midplane.

According to another feature, the air intake device comprises a skirt secured to the intake duct, extending same towards the air inlet and surrounding same, the air inlet and the skirt being configured in such a way as to form a baffle.

According to another feature, the air inlet comprises a downstream portion that is substantially tubular and has a free end oriented towards the intake duct, as well as a first flange provided on the outside of the downstream portion and connected in a fluid tight manner to the ring joint. To complement this, the skirt comprises a first part connected to the intake duct and a tubular second part, secured to the first part and positioned around the downstream portion of the air inlet, the second part having a free end which is separated from the intake duct by a greater distance than the free end of the downstream portion of the air inlet.

According to another feature, the first part comprises an interior face in the continuation of the intake duct.

According to another feature, the air inlet comprises an upstream edge, a downstream edge offset in the downstream according to the direction in which the airflow flows with respect to the upstream edge, as well as a leading edge positioned below the downstream edge. To complement this, the air intake device comprises a deflector, having:
a front edge substantially perpendicular to the direction of flow of the airflow in operation and offset in the upstream direction with respect to the leading edge of the air inlet and separated from the reference surface by a greater distance than the leading edge of the air inlet,
an upper face which extends from the front edge as far as a rear edge positioned at the air inlet, between the leading edge of the air inlet and the reference surface.

According to another feature, the air intake device has a valve configured to occupy open and closed states, and a given depth when the valve is in the closed state. To complement this, the front edge of the deflector is separated from the reference surface by a distance comprised between 15 and 25% of the depth of the air intake device.

According to another feature, the air inlet has a given length in a measurement plane substantially parallel to the reference surface and containing the front edge of the deflector. To complement this, in the measurement plane, the front edge of the deflector is separated from the air inlet by a distance comprised between 15 and 25% of the given length of the air inlet.

### BRIEF DESCRIPTION OF THE DRAWINGS

Further features and advantages will become apparent from the following description of the invention, which description is given solely by way of example, with reference to the appended drawings in which:

FIG. 1 is a side view of an aircraft,

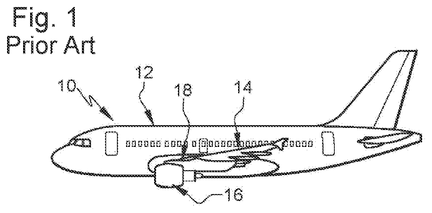

FIG. 2 is a longitudinal section through an air intake device, illustrating an embodiment of the prior art,

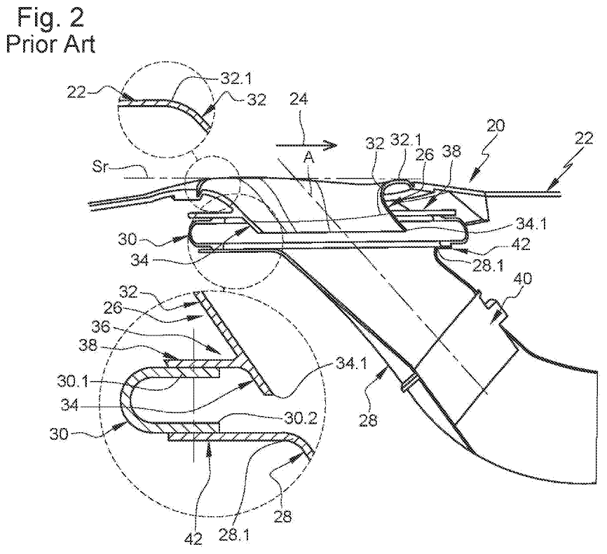

FIG. 3 is a schematic depiction of the air intake device visible in FIG. 2, forming a closed cavity, and of the airflows circulating over and inside the closed cavity,

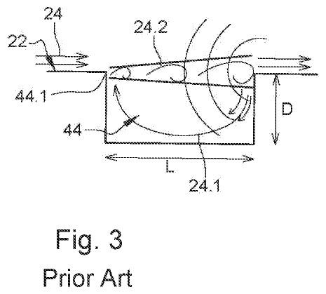

FIG. 4 is a longitudinal section through an air intake device, illustrating an embodiment of the invention,

FIG. 5 is a longitudinal section of a part of the air intake device visible in FIG. 4,

FIG. 6 is a side view of an air intake device, illustrating an embodiment of the invention,

FIG. 7 is a face-on view of the air intake device visible in FIG. 6,

FIG. 8 is a longitudinal section of the air intake device visible in FIG. 6,

FIG. 9 is a longitudinal section through an air intake device, illustrating an embodiment of the invention, and

FIG. 10 is a top-down view of the air intake device visible in FIG. 9.

### DETAILED DESCRIPTION OF THE PREFERRED EMBODIMENTS

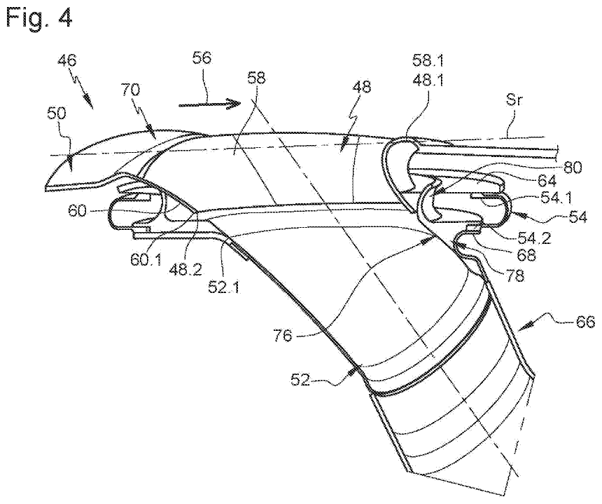

According to one embodiment visible in FIG. 4, an aircraft comprises at least one aerodynamic wall 50 and at least one air intake device 46.

According to one configuration, the air intake device 46 comprises an air inlet 48 configured to be connected to the aerodynamic wall 50, an intake duct 52 separated from the air inlet 48 and configured to be connected to an engine of an aircraft propulsion unit, and a ring joint 54 connecting the air inlet 48 and the intake duct 52, which is positioned around the air inlet 48 and around the intake duct 52. When the aircraft is in flight, an airflow 56 flows in a direction of flow embodied by an arrow in FIG. 4, substantially parallel to the aerodynamic wall 50.

The air inlet 48 comprises a flared upstream portion 58 which has an emergent end 58.1 connected to the aerodynamic wall 50, a substantially tubular downstream portion 60, having a free end 60.1 oriented towards the intake duct 52, and a junction zone 62 where the flared downstream and upstream portions 58, 60 meet, as well as a first flange 64 provided on the outside of the downstream portion 60 and positioned approximately at the junction zone 62.

According to one embodiment, the air inlet 48 is of the flush type. Thus, the emergent end 58.1 of the flared upstream portion 58 is positioned in a reference surface Sr substantially parallel to the direction of flow of the airflow 56.

The intake duct 52 comprises a valve 66 configured to occupy an open state in which it leaves the intake duct 52 uncovered and a closed state in which it occludes the intake duct 52. The latter comprises an end 52.1 oriented towards the air inlet 48 and a second flange 68 at the end 52.1.

The downstream portion 60 of the air inlet 48 and the intake duct 52 are tubular, substantially aligned and have the same axis A.

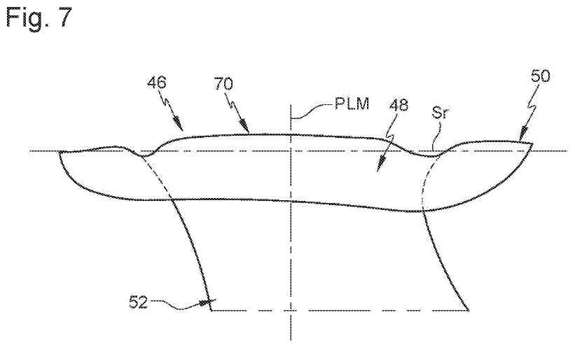

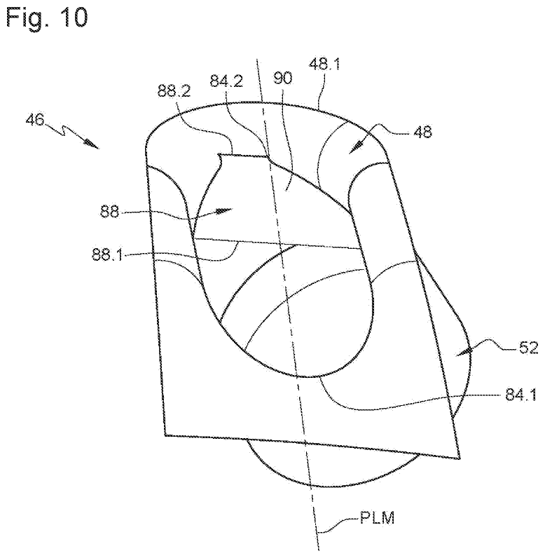

For the remainder of the description, a longitudinal midplane PLM (visible in FIGS. 7 and 10) corresponds to the plane containing the axis A and the direction of flow of the airflow 56. A transverse plane is a plane perpendicular to the direction of flow of the airflow 56. The terms upstream and downstream refer to the direction of flow of the airflow 56, which flows from upstream to downstream.

In one arrangement, the air inlet 48, the intake duct 52 and the ring joint 54 are substantially symmetrical with respect to the longitudinal midplane PLM.

In one configuration, the air intake device 46 is inclined at an angle. Thus, the axis A and the direction of flow of the airflow 56 form, in the longitudinal midplane PLM, an angle smaller than 80° and comprised between 50 and 70°.

The first and second flanges 64, 68 are separated from one another. They are substantially mutually parallel.

The ring joint 54 has a C-shaped cross section and comprises a first branch 54.1 connected to the first flange 64 by a fluid tight connection, as well as a second branch 54.2 connected to the second flange 68 by a fluid tight connection.

However it is embodied, the ring joint 54 is configured to ensure sealing between the air inlet 48 and the intake duct 52 despite any possible relative movements between the air inlet 48 and the intake duct 52.

The air inlet 48, the intake duct 52 and the ring joint 54 are not described further since they may be identical to those of the prior art. Whatever the embodiment, the air inlet 48 extends between a first end 48.1 emerging at the aerodynamic wall 50 and positioned on the reference surface Sr and a second end 48.2 oriented towards the intake duct 52. The latter comprises a first end 52.1 oriented towards the air inlet 48 and spaced away from the second end 48.2 of the air inlet 48. Finally, the ring joint 54 connects the air inlet 48 and the intake duct 52, surrounding these.

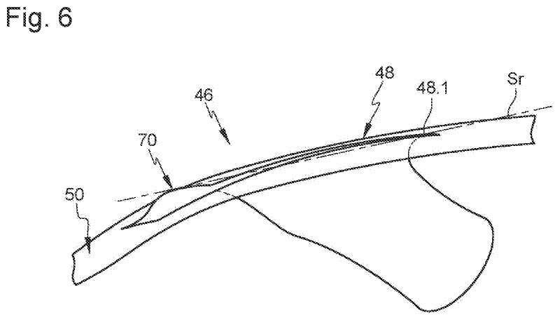

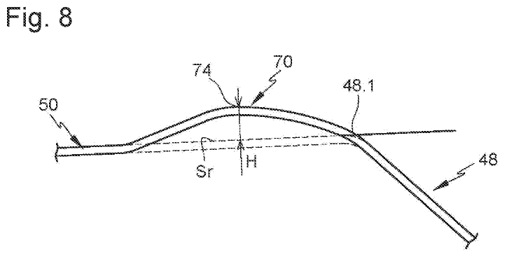

According to a feature visible in FIGS. 6 to 8, the air intake device 46 comprises at least one protrusion 70 projecting from the reference surface Sr (visible in FIG. 8) of the aerodynamic wall 50 in the absence of a protrusion 70, and positioned upstream of the air inlet 48 in the vicinity of or at the first end 48.1 of the air inlet 48. This protrusion and the air inlet 48 exhibit a continuous profile with no points of inflection.

According to one configuration, the protrusion 70 is positioned symmetrically with respect to the longitudinal midplane PLM.

In the longitudinal midplane PLM, the protrusion 70 has a profile which, from upstream to downstream, is coincident with the reference surface Sr, progressively diverges from the reference surface Sr as far as a summit 74, then progressively converges towards the reference surface Sr until it coincides with the reference surface Sr. According to one configuration, the profile of the protrusion 70 is substantially symmetrical with respect to a transverse plane passing through the summit 74.

According to one configuration, the protrusion 70 has, at the summit 74, a height H (distance separating the summit 74 and the reference surface Sr) that is greater than or equal to 10 mm. As a preference, the height of the protrusion 70 is greater than or equal to 24 mm.

According to one configuration, the protrusion 70 is a discrete feature and has a profile that is substantially identical in the longitudinal midplane PLM to that which it has in a transverse plane passing through the summit 74. According to one embodiment, the air intake device 46 comprises a single discrete protrusion 70 positioned on the longitudinal midplane PLM. According to another embodiment, the air intake device 46 comprises several discrete protrusions 70 distributed along a straight line and perpendicular to the longitudinal midplane PLM, or along a curved line following the first end 48.1 of the air inlet 48.

According to another configuration, the protrusion 70 is linear and extends along a path that is symmetrical with respect to the longitudinal midplane PLM. According to one embodiment, this path is rectilinear and extends in a transverse plane, as illustrated in FIG. 7. According to another embodiment, the path is curved, notably as an arc of a circle, and follows the first end 48.1 of the air inlet 48. According to one configuration, the linear protrusion 70 has a profile that is constant over the entire length of the path. According to another configuration, the path of the protrusion 70 has two ends distant from the longitudinal midplane PLM. With this configuration, the protrusion 70 has a profile that varies continuously and progressively from the longitudinal midplane towards each of the two ends of the path of the protrusion 70, this protrusion having a maximum height at the longitudinal midplane PLM and a zero height at the two ends of the path of the protrusion 70.

As in the prior art, when the valve 66 is in the closed state, the air intake device 46 forms a closed cavity. Unlike in the prior art, the protrusion 70 limits the onset of a phenomenon of coupling between a return airflow formed in the closed cavity and a disturbed flow 24.2 appearing over the air inlet 48, thereby making it possible to reduce the aerodynamic noise liable to be generated by the air intake device 46.

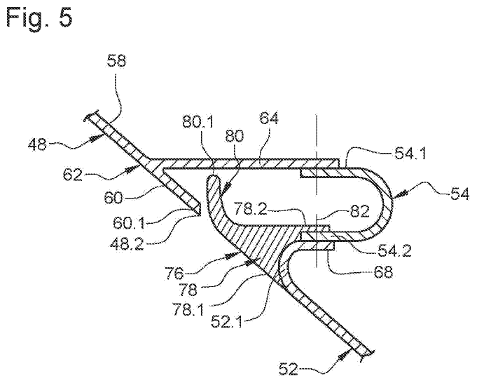

According to another feature visible in FIGS. 4 and 5, the air intake device 46 comprises a skirt 76 secured to the intake duct 52, extending the latter towards the air inlet 48 and surrounding the air inlet 48.

According to one embodiment, the skirt 76 comprises a first part 78 connected to the intake duct 52 and a tubular second part 80, secured to the first part 78 and positioned around the downstream portion 60 of the air inlet 48 and separated therefrom, the second part 80 having a free end 80.1 which is separated from the intake duct 52 by a greater distance than the free end 60.1 of the downstream portion 60 of the air inlet 48. Thus, the air inlet 48 and the skirt 76 are configured to form a baffle which prevents an airflow from entering towards the ring joint 54, in the zone delimited by the first and second flanges 64, 68 and the ring joint 54.

This solution also makes it possible to limit the onset of aerodynamic noise.

The skirt 76 is dimensioned in such a way that the free end 80.1 is as close as possible to the first flange 64 of the air inlet 48.

According to one embodiment, the first part 78 comprises an interior face 78.1 in the continuation of the intake duct 52, and a third flange 78.2 pressed intimately against the second flange 68 of the intake duct 52 and configured to house the second branch 54.2 of the ring joint. According to this embodiment, the second branch 54.2 of the ring joint 54 is interposed between the second and third flanges 68, 78.2. Connecting elements 82, distributed over the entire periphery of the intake duct 52, connect the intake duct 52, the ring joint 54 and the skirt 76.

In one arrangement, the first part 78 is configured to conform to the shapes of the intake duct 52 and those of the second branch 54.2 of the ring joint 54.

The skirt 76 may be made of metal, of plastic or of composite material. It may be molded or printed. Of course, the invention is not restricted to these methods for manufacturing the skirt 76.

In operation, as illustrated in FIG. 10, the air inlet 48 comprises an upstream edge 84.1 and a downstream edge 84.2 opposite the upstream edge 84.1 and offset downstream according to the direction in which the airflow 56 flows with respect to the upstream edge 84.1. When the valve 66 is in the closed state, the air intake device 46 forms a closed cavity and has a depth corresponding to the distance that separates the reference surface Sr and the valve 66, as measured at the axis A. Because the air intake device 46 is inclined at an angle, the air inlet 48 has, below the downstream edge 84.2, a leading edge 86 that splits the airflow 56 into an incoming airflow and an outgoing airflow.

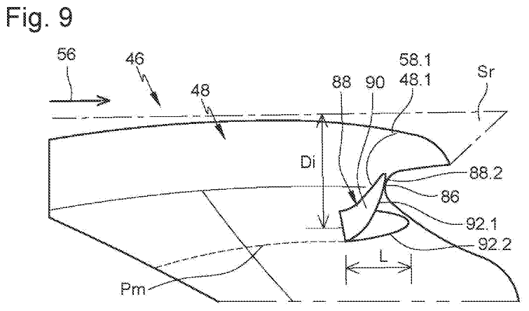

According to another feature visible in FIGS. 9 and 10, the air intake device 46 comprises a deflector 88 which covers the leading edge 86 of the air inlet 48. This deflector 88 has a front edge 88.1 positioned in a transverse plane offset in the upstream direction with respect to the leading edge 86 of the air inlet 48 and separated from the reference surface Sr by a greater distance than the leading edge 86 of the air inlet 48. This deflector 88 comprises an upper face 90 which extends from the front edge 88.1 as far as a rear edge 88.2 positioned at the air inlet 48, between the leading edge 86 of the air inlet 48 and the reference surface Sr.

The front edge 88.1 of the deflector 88 is separated from the reference surface Sr by a distance Dc comprised between 15 and 25% of the depth of the air intake device 46. In a measurement plane Pm substantially parallel to the reference surface Sr and containing the front edge 88.1 of the deflector 88, the air inlet 48 has a given length (the dimension being measured at the longitudinal midplane PLM). In this measurement plane Pm, the front edge 88.1 of the deflector 88 is separated from the air inlet 48 by a distance Lc comprised between 15 and 25% of the given length of the air inlet 48.

The upper face 90 of the deflector 88 may be flat or may have a concave shape.

In one configuration, the deflector 88 comprises a single wall, of constant thickness, which comprises the upper face 90 and extends from the front edge 88.1 as far as the air inlet 48.

According to another configuration visible in FIG. 9, the deflector 88 comprises a first wall 92.1 which comprises the upper face 90 and extends from the front edge 88.1 as far as the air inlet 48, and a second wall 92.2, substantially parallel to the reference surface Sr, which extends from the front edge 88.1 as far as the air inlet 48.

The air intake device 46 comprises a connection connecting the deflector 88 and the air inlet 48. By way of example, the deflector 88 is connected to the air inlet 48 by bonding.

The deflector 88 may be made of metal, of plastic or of composite material.

The deflector 88 prevents the airflow 56 from entering the air intake device 46 when the valve 66 is in the closed state, thereby limiting the onset of aerodynamic noise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
at least one aerodynamic wall along which an airflow flows in a direction of flow during operation,
an air intake device comprising:
an air inlet opening onto the aerodynamic wall,
an intake duct separated from the air inlet and a ring joint connecting the air inlet and the intake duct while surrounding these,
the air inlet extending between a first end positioned on a reference surface substantially parallel to the airflow and a second end oriented towards the intake duct,
the intake duct having a first end oriented towards the air inlet and spaced away from the second end of the air inlet;
wherein the air intake device comprises:
at least one protrusion projecting from the reference surface and positioned upstream of the air inlet in the direction of flow of the airflow, in a vicinity of or at the first end of the air inlet;
wherein the air inlet comprises:
an upstream edge,
a downstream edge offset in the downstream according to the direction in which the airflow flows with respect to the upstream edge, and
a leading edge positioned below the downstream edge, and
wherein the air intake device comprises a deflector comprising:
a front edge substantially perpendicular to the direction of flow of the airflow in operation and offset in an upstream direction with respect to the leading edge of the air inlet and separated from the reference surface by a greater distance than said leading edge of the air inlet, and
an upper face which extends from the front edge as far as a rear edge positioned at the air inlet, between the leading edge of the air inlet and the reference surface.

2. The aircraft according to claim 1, wherein the protrusion and the air inlet exhibit a continuous profile with no points of inflection.

3. The aircraft according to claim 1, wherein the air inlet is substantially symmetrical with respect to a longitudinal midplane, and wherein the protrusion is positioned symmetrically about the longitudinal midplane.

4. The aircraft according to claim 1, wherein the protrusion has a summit and a height at the summit that is greater than or equal to 10 mm.

5. The aircraft according to claim 3, wherein the protrusion is linear and extends along a path that is symmetrical with respect to the longitudinal midplane.

6. The aircraft according to claim 1, wherein the air intake device comprises a skirt secured to the intake duct, extending same towards the air inlet and surrounding same, the air inlet and the skirt being configured in such a way as to form a baffle.

7. The aircraft according to claim 6,
wherein the air inlet comprises a downstream portion that is substantially tubular and has a free end oriented towards the intake duct, as well as a first flange provided on the outside of the downstream portion and connected in a fluid tight manner to the ring joint, and
wherein the skirt comprises a first part connected to the intake duct and a tubular second part, secured to the first part and positioned around the downstream portion of the air inlet, the second part having a free end which is separated from the intake duct by a greater distance than the free end of the downstream portion of the air inlet.

8. The aircraft according to claim 7, wherein the first part comprises an interior face in a continuation of the intake duct.

9. The aircraft according to claim 1,
wherein the air intake device has a valve configured to occupy open and closed states, and a given depth when the valve is in the closed state, and
wherein the front edge of the deflector is separated from the reference surface by a distance comprised between 15 and 25% of a depth of the air intake device.

10. The aircraft according to claim 1,
wherein the air inlet has a given length in a measurement plane substantially parallel to the reference surface and containing the front edge of the deflector, and
wherein, in the measurement plane, the front edge of the deflector is separated from the air inlet by a distance comprised between 15 and 25% of the given length of the air inlet.
